(19) United States
(12) Patent Application Publication
(10) Pub. No.: US 2013/0227706 A1
(43) Pub. Date: Aug. 29, 2013

(54) METHOD, APPARATUS AND SYSTEM FOR CONTROLLING READ RIGHTS OF DIGITAL CONTENTS

(71) Applicants: PEKING UNIVERSITY FOUNDER GROUP CO., LTD., (US); BEIJING FOUNDER APABI TECHNOLOGY LTD., (US)

(72) Inventors: Fengrui ZUO, Beijing (CN); Haitao WANG, Beijing (CN); Wei WAN, Beijing (CN); Ke HUANG, Beijing (CN); Jinbing YAN, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/779,414

(22) Filed: Feb. 27, 2013

(30) Foreign Application Priority Data
Feb. 29, 2012 (CN) 201210050893.1

(51) Int. Cl. G06F 21/10

(52) U.S. Cl. CPC G06F 21/10
USPC 726/27

(57) ABSTRACT

A method for controlling read rights of digital contents includes receiving, by a first service node, digital content information from a second service node implemented by a second server, wherein the digital content information includes digital contents and read rights of the digital contents, and both the first service node and the second service node are service nodes authenticated by a root service node, transmitting, by the first service node, a verification request to the root service node to verify whether the digital content information is authorized by the root service node, and parsing, by the first service node, the digital content information to obtain the digital contents and the read rights of the digital contents if a verification result shows that the digital content information is authorized by the root service node. An apparatus and system for implementing the method are also provided.

### CROSS REFERENCE OF RELATED APPLICATION

This application claims the benefits of priority to Chinese Patent Application No. 201210050893.1, filed on Feb. 29, 2012, the entire contents of which are incorporated herein by reference.

### FIELD

The present invention relates to digital rights management, and particularly to a method, apparatus and system for controlling read rights of digital contents.

### BACKGROUND

Digital publishing services have developed dramatically and digital publishing modes have become increasingly flexible along with the development and popularization of the Internet. Publishers typically would like to distribute as many copies of digital contents as possible and also control read rights of the digital contents by themselves instead of being defined by others.

In an existing method for controlling read rights of digital contents, a publisher system produces digital contents, defines read rights of the digital contents, packages and distributes both of them to a digital content sale system. The digital content sale system can distribute the read rights of the digital contents to a read terminal. The read terminal reads the digital contents after obtaining the read rights from the digital content sale system. Alternatively, the publisher system produces digital contents, defines read rights of the digital contents and distributes the read rights of the digital contents and the digital contents respectively to the digital content sale system. The digital content sale system can distribute the read rights of the digital contents to a read terminal, and the read terminal reads the digital contents after obtaining the read rights from the digital content sale system.

With the foregoing two methods, in the course of distribution of digital contents, only the digital content sale system can distribute the digital contents and the read rights of the digital contents to a customer. With such a service distribution mode, publishers' interest some time cannot be protected as the publishers may lose control of the read rights of the digital contents and cannot guarantee that all the uses of the digital contents through out of the distribution channels are secured.

### SUMMARY

Embodiments of the invention provide a method and service node for controlling read rights of digital contents so as to enable a child service node to distribute the read rights of the digital contents while ensuring the read rights of the digital contents not to be violated.

An embodiment of the invention provides a method for controlling read rights of digital contents. The method may include receiving, by a first service node, digital content information from a second service node. The digital content information may include digital contents and read rights of the digital contents. Both the first service node and the second service node are authenticated by a root service node. The first service node may transmit a verification request to the root service node to verify the digital content information. The first service node may parse the digital content information to obtain the digital contents and the read rights of the digital contents if the verification result shows that the digital content information is authorized by the root service node. The first service node may delete the digital content information when the verification result shows that the digital content information is not authorized by the root service node.

Another embodiment of the invention provides an apparatus for controlling read rights of digital contents. The apparatus may include a receiving module configured to receive digital content information transmitted from a preceding child service node. The digital content information may include digital contents and read rights of the digital contents. Both the apparatus and the preceding child service node are child service nodes authenticated by a root service node. The apparatus may further include a transmitting module configured to transmit a verification request to the root service node to verify the digital content information. The verification request may include the digital content information. The apparatus may further include a processing module configured to parse the digital content information to obtain the digital contents and the read rights of the digital contents if a verification result shows that the digital content information is authorized by the root service node. The apparatus may be configured to delete the digital content information if the verification result shows that the digital content information is not authorized by the root service node.

Another embodiment of the invention further provides a system for controlling read rights of digital contents. The system may include a current child service node configured to receive digital content information transmitted from a preceding child service node. The digital content information may include digital contents and read rights of the digital contents. Both the current child service node and the preceding child service node are child service nodes authenticated by a root service node. The current child service node may be configured to transmit a verification request carrying the digital content information to the root service node to verify the digital content information. The current child service node may be further configured to parse the digital content information to obtain the digital contents and the read rights of the digital contents if a verification result shows that the digital content information is authorized by the root service node or delete the digital content information if the verification result shows that the digital content information is not authorized by the root service node. The system may further include the root service node, which is configured to receive the verification request transmitted from the child service node, parse the digital content information, and to check the digital contents and the read rights of the digital contents in the digital content information to determine whether the digital content information is authorized.

### BRIEF DESCRIPTION OF THE DRAWINGS

FIG. 1 is a schematic flow chart of a method for controlling read rights of digital contents according to an embodiment of the invention;

FIG. 2 is a schematic flow chart of a method for controlling read rights of digital contents according to another embodiment of the invention;

FIG. 3 is a schematic flow chart of a client terminal obtaining digital contents according to an embodiment of the invention;

FIG. 4 is a schematic diagram of an apparatus for controlling read rights of digital contents according to another embodiment of the invention; and

FIG. 5 is a schematic diagram of a system for controlling read rights of digital contents according to another embodiment of the invention.

### DETAILED DESCRIPTION OF THE EMBODIMENTS

A general implementation principle and particular implementations of the technical solution according to the embodiments of the invention and advantageous effects that they can achieve correspondingly will be set forth below in details with reference to the drawings.

A digital content distribution system may be implemented by a computer network, and may include a root service node and multiple child service nodes. The root service node distributes digital contents and read rights to child service nodes. A child service node may distribute the digital contents and read rights to customers. A child service node may also have downstream child service nodes, and distribute the digital contents and read rights to the downstream child service nodes. The downstream service nodes distribute the digital contents and read rights to customers or to further downstream child service nodes. Each service node may be implemented by a computer or a server.

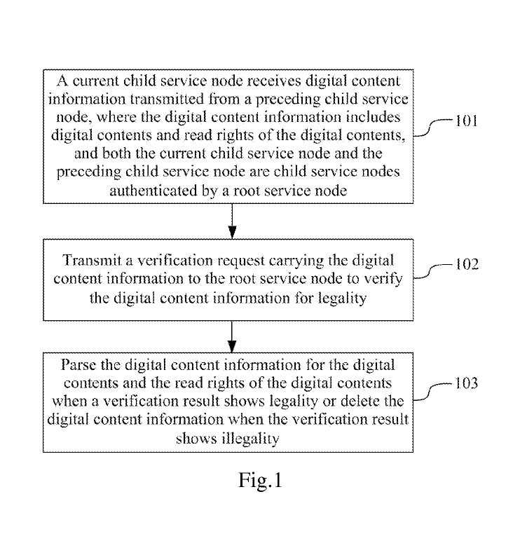

FIG. 1 shows a method for controlling read rights of digital contents according to an embodiment of the invention. As shown in FIG. 1, in step 101, a current child service node receives digital content information from a preceding child service node. The digital content information may include digital contents and read rights of the digital contents. Both the current child service node and the preceding child service node may be previously authenticated by a root service node.

In step 102, the current child service node may send a verification request to the root service node for verifying the digital contents and/or the read rights of the digital contents. For example, the verification request may request the root service to verify whether the received digital contents are legally obtained, e.g., whether the copies are legal or are legally authorized to be distributed. In some embodiments, the verification request may carry the digital content information.

In step 103, if the verification result shows that the digital contents are authorized by the root service node, the current child service node may parse the digital content information to obtain the digital contents and the read rights of the digital contents. If the verification result shows that the digital contents are not authorized, the current child service node may delete the digital content information.

In some embodiments, the root service node may generate the digital contents and the read rights of the digital contents and package them together. The root service node may then transmit the packaged digital content information including the digital contents and the read rights of the digital contents to a child service node. The child service node may distribute the digital content information to another child service node or a client terminal. Through such a distribution network, the digital contents generated by the root service node can be widely distributed. For example, the current child service node can distribute the digital content information to another child service node. Both the current child service node and the other child service node are child service nodes authenticated by the root service node. The other child service node can send a verification request to the root service node to verify whether the digital content information is authorized by the root service node. The other child service node may parse the digital content information if it is authorized by the root service node.

When the root service node receives a verification request and digital content information for verification, the root service node may parse the digital content information to obtain the digital contents and the read rights of the digital contents. The root service node may check whether the read rights of the digital contents are authorized by the root service node. If they are, the root service node may return a verification result indicating that the digital content information is legal to the child service node. In some other embodiments, the root service node may send a certificate indicating that the read rights of the digital contents can be further distributed. If the digital content information is not legal, the root service node may send a verification result indicating that the digital content information is not legal.

The client terminal, when receives the digital content information, may send a verification request to the root service node to verify the digital content information. If it is legal, the client terminal may receive a certificate from the root service node. The client terminal may then parse the digital content information according to the certificate and uses the digital contents in the digital content information. If it is illegal, the client terminal may delete the digital content information.

The root service node can be a server in a publishing system, and the child service node can be a server in a digital content integration system or a server in a digital content sale system. The servers are connected through computer networks.

As can be apparent from the foregoing description, with the method for controlling read rights of digital contents according to an embodiment of the invention, a verification request is transmitted to the root service node (e.g., the publisher system) upon receiving the digital content information to ensure the read rights of the digital contents distributed from the respective child service nodes (e.g., in the digital content sale system, the digital content integration system, etc.) to be consistent with that distributed from the root service node. Thus, a child service node can be enabled to distribute read rights of digital contents while ensuring the read rights of the digital contents not to be falsified or violated.

The method for controlling read rights of digital contents according to an embodiment of the invention will be detailed below. According to some embodiments, an exemplary publishing system may include a publisher system including a root service node A, a digital content integration system including a child service node B, a digital content sale system including a child service node C, and a client terminal D.

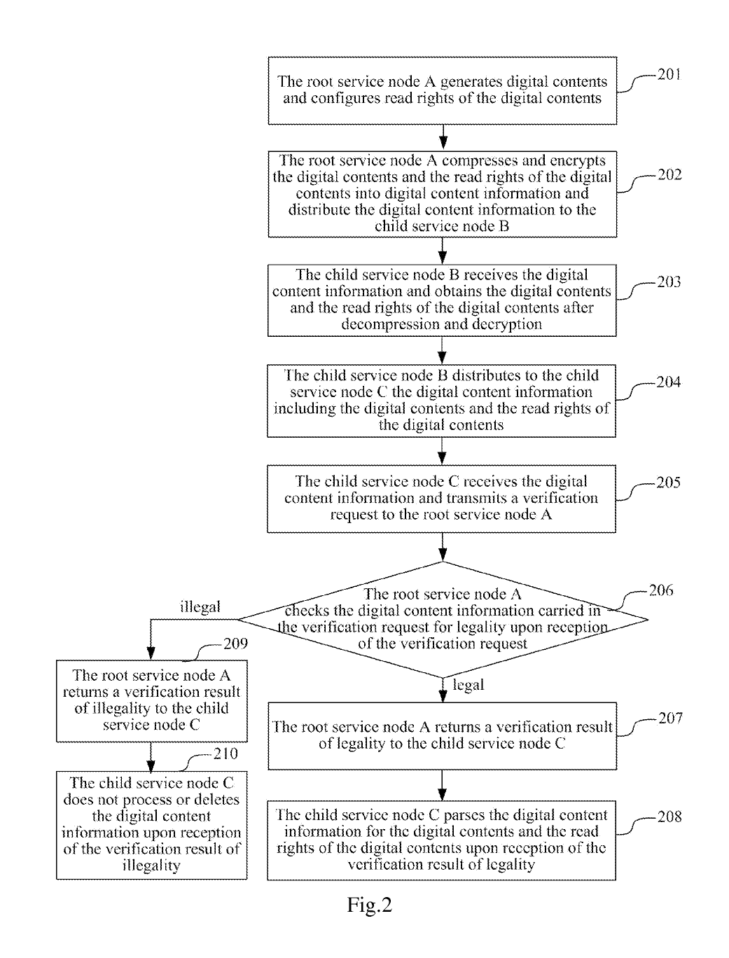

FIG. 2 shows an exemplary embodiment of a distribution method. As shown in FIG. 2, in step 201, the root service node A generates digital contents and configures read rights for the digital contents. In step 202, the root service node A may compress and encrypt the digital contents and the read rights of the digital contents into digital content information for distribution to the child service node B and other child service nodes.

In step 203, the child service node B receives the digital content information and obtains the digital contents and the read rights of the digital contents after decompression and decryption. The child service node B can provide the client terminal D with the digital contents or can distribute the digital content information to another child service node. For example, in step 204, the child service node B may distribute the digital content information including the digital contents and the read rights of the digital contents to the child service node C.

In step 205, the child service node C receives the digital content information and transmits a verification request to the root service node A. The verification request may include the digital content information, which includes the digital contents and read right information.

In step 206, the root service node A checks the digital content information carried in the verification request. If it is legal, the process goes to the step 207; otherwise, the process goes to the step 209.

In step 207, the root service node A returns a verification result to the child service node C showing that the digital contention information is authorized. In step 208, the child service node C parses the digital content information to obtain the digital contents and the read rights of the digital contents.

In step 209, the root service node A returns a verification result to the child service node C showing that the digital content information is not authorized. In step 210, the child service node C does not process or deletes the digital content information upon receiving the verification result.

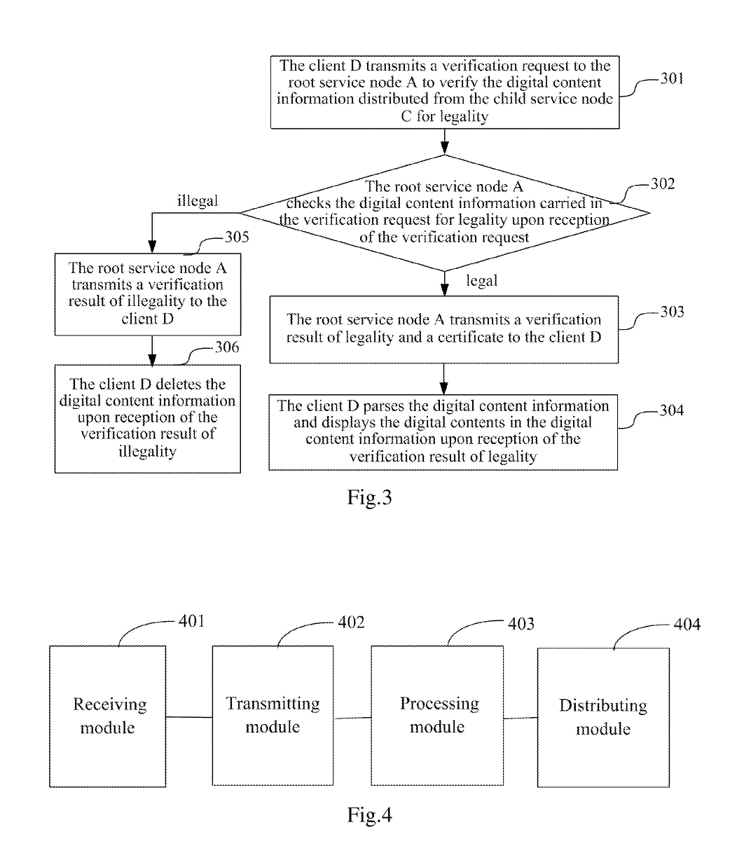

The child service node C can provide the client terminal D with the digital content information authorized by the root service node. The client terminal D may perform the following operations as illustrated in FIG. 3 before purchasing the read rights of the digital contents from the child service node C.

As shown in FIG. 3, in step 301, the client terminal D transmits a verification request to the root service node A to verify the digital content information distributed from the child service node C. The verification request may carry the digital content information. In step 302, the root service node A checks the digital content information carried in the verification request. If it is authorized by the root service node, the process goes to the step 303; otherwise, the process goes to the step 305. In step 303, the root service node A transmits a verification result showing that the digital content information is authorized and a certificate to the client terminal D. In step 304, client terminal D parses the digital content information according to the certificate and displays the digital contents in the digital content information. The client terminal can purchase the read rights of the digital contents and uses the digital contents.

In step 305, the root service node A transmits a verification result to the client terminal D showing that the digital content information is not authorized. In step 306, the client terminal D deletes the digital content information upon receiving the verification result.

As described above, with the method for controlling read rights of digital contents according to the embodiments of the present invention, a verification request is transmitted to the root service node (e.g., in a publisher system) upon receiving the digital content information to ensure the read rights of the digital contents distributed from the respective child service nodes (e.g., in a digital content sale system, a digital content integration system, etc.) to be consistent with that distributed from the root service node. Thus, a child service node can be enabled to distribute read rights of digital contents while ensuring the read rights of the digital contents not be violated or falsified.

An embodiment of the invention further provides an apparatus for controlling read rights of digital contents. As illustrated in FIG. 4, the apparatus may include a receiving module 401 configured to receive digital content information transmitted from a preceding child service node. The digital content information may include digital contents and read rights of the digital contents. Both the apparatus and the preceding child service node may be child service nodes authenticated by a root service node. The apparatus may also include a transmitting module 402 configured to transmit a verification request carrying digital content information to the root service node to verify the digital content information. The apparatus may also include a processing module 403 configured to parse the digital content information to obtain the digital contents and the read rights of the digital contents when a verification result shows legality or to delete the digital content information when the verification result shows illegality. In some embodiments, the apparatus may further include a distributing module 404 configured to distribute the digital content information to another child service node.

As can be apparent from the foregoing description, with the apparatus for controlling read rights of digital contents according to the embodiment of the invention, a verification request is transmitted to the root service node (e.g., in a publisher system) upon receiving the digital content information to thereby ensure the read rights of the digital contents distributed from the respective child service nodes (e.g., in a digital content sale system, a digital content integration system, etc.) to be consistent with that distributed from the root service node without being falsified. Thus, a child service node can be enabled to distribute read rights of digital contents while ensuring the read rights of the digital contents not to be violated or falsified.

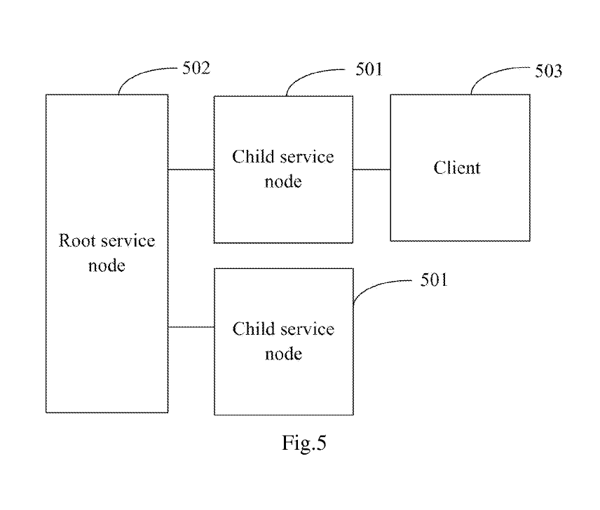

The present disclosure further provides a system for controlling read rights of digital contents. As illustrated in FIG. 5, the system may include at least one child service node 501 configured to receive digital content information from a preceding child service node or a root service node. The digital content information may include digital contents and read rights of the digital contents. Both the current child service node and the preceding child service node may be authenticated by the root service node. The child service node 501 may also be configured to transmit a verification request to the root service node to verify the digital content information for legality. The verification request may carry the digital content information. When the child service node 501 receives a verification result, which shows that the digital contents are legal, the child service node 501 may parse the digital content information to obtain the digital contents and the read rights of the digital contents. If the verification result shows that the digital contents are not legal, the child service node 501 may delete the digital content information. In some embodiments, the child service node 501 may be further configured to distribute the digital content information to another child service node.

The system may also include the root service node 502. The root service node 502 may be configured to receive the verification request from the child service node 501. After receiving the verification request, the root service node 502 may parse the digital content information to obtain the digital contents and the read rights of the digital contents in the digital content information. The root service node 502 may check the digital contents and the read rights of the digital contents in the digital content information for legality.

As shown in FIG. 5, a client computer 503 may be connected to the child service node 501 through a computer network. In some embodiments, the client computer 503 may be configured to transmit a verification request to the root service node 502 to verify the digital content information for legality when receiving the digital content information. If the verification result shows that the digital contents are legal, the client computer 503 may receive a certificate from the root service node 502. The client computer 503 may also parse the digital content information according to the certificate and display the digital contents in the digital content information.

As can be apparent from the foregoing description, with the method, apparatus and system for controlling read rights of digital contents according to the embodiments of the invention, a child service node can transmit a verification request to the root service node (e.g., in a publisher system) to ensure the read rights of the digital contents distributed from the respective child service nodes (e.g., in a digital content sale system, a digital content integration system, etc.) to be consistent with that distributed from the root service node. Thus, if the verification result is positive, the child service node can be enabled to distribute read rights of digital contents.

Those skilled in the art should appreciate that the embodiments of the invention can be embodied as a method, a system or a computer program product. The invention can be implemented with a combination of computer software and hardware. Furthermore, the invention can be embodied in the form of a computer program product in one or more computer readable storage medium (including but not limited to a disk memory, a CD-ROM, an optical memory, etc.) in which computer readable and executable program codes are stored. The program codes, when executed by, e.g., by one or more processors, can perform the methods described in this disclosure.

Some embodiments of the invention have been described in a flow chart and/or a block diagram of a method, a device (system) and a computer program product. It should be appreciated that the flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of a programmable data processing device to produce a machine so that the instructions executed on the computer or the processor of the programmable data processing device perform the functions specified in the flow(s) of the flow chart and/or the block(s) of the block diagram.

These computer program instructions can also be stored into a computer readable memory capable of directing the computer or the other programmable data processing device to operate in a specific manner, for example, to perform the disclosed methods, so that the instructions stored in the computer readable memory create an article of manufacture including instruction means which perform the functions specified in the flow(s) of the flow chart and/or the block(s) of the block diagram.

These computer program instructions can also be loaded onto the computer or the programmable data processing device so that a series of operational steps are performed on the computer or the programmable data processing device to create a computer implemented process. The instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

What is claimed is:

1. An apparatus for controlling read rights of digital contents, comprising:
a receiving module configured to receive digital content information from a first service node, wherein the digital content information includes digital contents and read rights of the digital contents, and both the apparatus and the first service node are service nodes authenticated by a root service node;
a transmitting module configured to transmit a verification request to the root service node for verifying whether the digital content information is authorized by the root service node; and
a processing module configured to parse the digital content information to obtain the digital contents and the read rights of the digital contents if a verification result shows that the digital content information is authorized by the root service node.

2. The apparatus of claim 1, further comprising:
a distributing module configured to distribute the digital content information to another service node.

3. The apparatus of claim 1, wherein the processing module is further configured to delete the digital content information if the verification result shows that the digital content information is not authorized by the root service node.

4. The apparatus of claim 1, wherein the verification request includes the digital content information.

5. A method for controlling read rights of digital contents, comprising:
receiving, by a first service node implemented by a first server, digital content information from a second service node implemented by a second server, wherein the digital content information includes digital contents and read rights of the digital contents, and both the first service node and the second service node are service nodes authenticated by a root service node;
transmitting, by the first service node, a verification request to the root service node to verify whether the digital content information is authorized by the root service node; and
parsing, by the first service node, the digital content information to obtain the digital contents and the read rights of the digital contents if a verification result shows that the digital content information is authorized by the root service node.

6. The method of claim 5, further comprising deleting the digital content information if the verification result shows that the digital content information is not authorized by the root service node.

7. The method of claim 5, further comprising distributing the digital content information to a third service node.

8. The method of claim 5, further comprising transmitting the digital content information to a client terminal.

9. The method of claim 8, further comprising
transmitting, by the client terminal, a verification request to the root service node to verify the digital content information;
receiving, by the client terminal, a certificate from the root service node; and
parsing, by the client terminal, the digital content information according to the certificate and displaying the digital contents in the digital content information if a verification result shows that the digital contention information is authorized by the root service node.

10. The method of claim 5, further comprising:
receiving, by the root service node, the verification request transmitted from the first service node;
parsing, by the root service node, the digital content information; and
checking, by the root service node, the digital contents and the read rights of the digital contents in the digital content information to determine whether the digital content information is authorized by the root service node.

11. The method of claim 5, wherein the verification request includes the digital content information.

12. A system for controlling read rights of digital contents, comprising:
a first service node, implemented by a first server, configured to receive digital content information transmitted from a second service node, implemented by a second server, wherein both the first and second service node are service nodes authenticated by a root service node,
wherein the first service node is configured to transmit a verification request to the root service node to verify whether the digital content information is authorized by the root service node, and to parse the digital content information to obtain the digital contents and the read rights of the digital contents when a verification result shows that the digital content information is authorized by the root service node; and
the root service node configured to receive the verification request transmitted from the first service node, parse the digital content information, and determine whether the digital contents and the read rights of the digital contents in the digital content information are authorized by the root service node.

13. The system of claim 12, wherein the first service node is further configured to distribute the digital content information to another service node.

14. The system of claim 12, wherein the system further comprises a client terminal configured to transmit a verification request to the root service node to verify whether the digital content information is authorized by the root service node when the client terminal receives the digital content information, and receive a certificate from the root service node, parse the digital content information according to the certificate and display the digital contents in the digital content information when a verification result shows that the digital contention information is authorized by the root service node.

15. The system of claim 12, wherein the first service node is configured to delete the digital content information if the verification result shows that the digital content information is not authorized by the root service node.

16. The system of claim 12, wherein the verification request includes the digital content information.
